(19) United States
(12) Patent Application Publication
(10) Pub. No.: US 2003/0144943 A1
(43) Pub. Date: Jul. 31, 2003

(54) Business method for defferring the payment of a broker's commission or fee

(76) Inventor: George Zivan, Troy, MI (US)

Correspondence Address: REISING, ETHINGTON, BARNES, KISSELLE, P.C., P O BOX 4390, TROY, MI, 48099-4390, US

(21) Appl. No.: 10/058,554

(22) Filed: Jan. 28, 2002

(51) Int. Cl. G06F 17/60

(52) U.S. Cl. 705/37

(57) ABSTRACT

A business method and process that enables an entity to retain and defer payment of a broker's commissions or fees, which would be due and payable at the closing, until a time after the closing. The compensation, which typically is called commissions or fees, would be financed whereby the applicant can pay the compensation in installments, a lump sum, or a combination thereof, later in time, allowing them to retain the amount of the commissions or fees, and pay nothing at the real estate closing. The broker themselves can finance the commission or fee (directly or through the broker's separate entity), or a financing entity can finance the commissions or fees. An administrator can also be involved as a go-between for the broker and financing entity, or the applicant and the financing entity.

### COPYRIGHT NOTICE

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever. 37 C.F.R. §1.71 (e).

### BACKGROUND OF THE INVENTION

2. Field of the Invention

The present invention relates to a method for financing all or a portion of a broker's commissions or fees, thereby producing the useful, concrete, and tangible result of the right to retain all or a portion of the broker's commissions and/or fees at the closing of a sales transaction, and the duty to pay the commissions or fees at a later time, either in installments, a lump sum, or any other combination or variance of payments.

2. Description of the Related Art

Brokers, including real estate brokers, are a vital portion of the economy. Real estate brokers are usually paid by a commission, or fee, or a combination of both. When one buys or sells a house through a real estate broker, the following entities are usually involved, (1) the seller, (2) the broker, (3) the title insurance company, and (4) the buyer.

In the prior art, the sale comprises the buyer paying the sales price to the broker or title insurance company, who then transfers the finds to the seller after withdrawing the seller's closing costs, commissions and/or fees. The broker's sales commission is usually paid by the seller, but can also be paid by the buyer, or both. Out of the sales price, the broker or title company then pays both the seller and broker in effect, simultaneously, at the “closing,” while the broker and/or title insurance company may retain a portion of the commission or fee. The closing is usually performed at a title office, office of the lender, or listing broker's office.

What is needed therefore, is a method that allows an “applicant” (seller and/or buyer who finances the commission or fee under the invention) a method to avoid paying the sales commission at the closing, but to have the broker's commission financed and paid by the broker, broker's sub-entity (e.g. the broker's “commission financing department”), financing entity, or administrator, whereby the seller (or in some circumstances the buyer, or both) can retain what they would normally have to pay in broker commissions or fees. The applicant would then pay the broker's commissions or fees later, or in installments. The applicant would pay this to the broker, financing entity, or administrator who financed the commissions or fees.

Innovations regarding financing have been provided in the related art that are described as follows. Even though these innovations may be suitable for the specific individual purposes to which they address, they vastly differ from the present invention as will be described.

U.S. Pat. No. 5,644,726 to Oppenheimer discloses a, “. . . method for financing purchase of real property by mortgagors through a combination of mortgagee debt principal and partial mortgagee equity interest in the purchased property . . . ” The novelty of the '726 patent is described in column 4, lines 29-32, as, “. . . its mechanism for guaranteeing substantially lower homeowner payments, while simultaneously assuring attractive and safe financial returns to mortgage investors.” The '726 patent benefits only the home purchaser with potential lower monthly payments, and the mortgage investor (possibly a bank) with equity in the house, unlike the applicant's invention, which usually benefits the seller by deferring the payment of the real estate broker's sales commission. As described in column 1, lines 35-54, the '726 patent was born out of the 1970s, when homeowners that were at a fixed, relatively low, interest rate; while the interest rates jumped, along with housing, exposing a risk in mortgage lending.

U.S. Pat. No. 6,216,115 to Barrameda et al discloses a “An integrated credit card data processing method that allows transactions to be processed whether as a payment or as a receipt of payment.” The '115 patent discloses a method for allowing someone to purchase things or as a means for accepting payment as a merchant. See column 1, lines 24-29. The patent refers to a credit card as a single directional payment method because the card can only be used to purchase or obtain a cash advance—the user can obtain money, goods, or services, in consideration for going in debt to the card issuer (usually a bank). The '115 invention is called multidirectional because it allows one to sell goods or services and receive money or credit in return. This is not similar to the applicant's invention. The '115 patent does not allow for, nor suggest the deferring of a sales commission.

U.S. Pat. No. 6,263,320 to Danilunas et al discloses a method for financing a car by purchasing other things, where some proceeds are put aside to purchase the car. Therefore when one purchases the car it costs less because proceeds from other goods or services would be applied toward the down payment. This does not allow for, nor suggest, the deferring of paying a sales commission.

Innovations for other financial practices have been provided in the prior art. Even though these innovations may be suitable for the specific individual purposes to which they address, they would not be suitable for the purposes of the present invention.

The invention offers many consumer benefits. In the context of the sale of real estate, the ability to restructure and delay the payment of commissions and/or fees, which could outpace the inflation rate, will relieve consumers from a large financial burden at a critical juncture of transition and at one of the most stressful times of their lives. With the immediate concern of the sales commission removed, sellers-who are typically the payers of commissions-will feel at greater liberty to upgrade their homes to top selling condition so they might sell faster and receive the highest possible price. They will also be able to afford moving costs, new appliances, and perhaps even some new furnishings that they might otherwise have done without. This invention allows the seller to retain proceeds of the sale that would otherwise be paid to a broker at the closing.

The invention offers many benefits to brokers. Brokers of any sort, through this invention, will gain one more dimension through which to distinguish themselves from the competition while fulfilling an important consumer need. This invention also helps brokers to overcome the largest obstacle to the broker's efforts to procure listings, namely the seller's reluctance to pay a commission.

The invention offers many benefits to financing entities. Financing entities, including lenders and underwriters, budget large sums of money for marketing and advertising, largely to lure willing and able borrowers. Charging consumers higher fees and/or higher interest rates ultimately offsets this huge expense. The invention will provide the financing entity with a steady stream of borrowers without their having to spend fortunes in advertising. In addition, because financing entities do not presently target consumers for the specific purpose of financing sales commissions, this invention provides a class of borrowers the financing entity would not likely procure through other means. Real estate franchisors with the means to do so would be excellent financing entities as they have a built-in constituency, the broker franchisees, to market their financing program and to set both the franchisor and it's member brokers apart from the crowd.

The invention offers many benefits to administrators. In some cases, in accordance with the invention, it will be preferable for the real estate broker to not enter into an agreement with a financing entity directly. This is because the small real estate broker might realize significantly better terms from a national lender by having the terms negotiated by a much larger entity. For example, a real estate broker's franchise company, which can market the program to it's large constituency, the franchisee member brokers, presents the financing entity with much greater potential for profit than a single broker and would make an ideal administrator for the invention.

The real estate franchisor or other entity involved in facilitating or administrating the program will be handsomely rewarded, both in revenues and through its unique position at the heart of a new and dynamic business.

The administrator need not have large capital because they are not originating the funds. Their fees and the extent of their involvement would be a matter of agreement between them, the real estate broker and the financing entity.

### SUMMARY OF THE INVENTION

This invention allows for flexibility for the payment of broker's commissions and/or fees, as this risk can be born by the broker, financing entity, administrator, or any combination of the above, or their equivalents.

The novelty of the invention is its methods for allowing the seller, or in some cases the buyer, or combination of seller and buyer, to not pay the broker's commissions and/or fees that, in the prior art, were due in fill at the real estate closing.

This applicant's business method-type invention introduces new concepts that allow the seller and/or buyer to retain what would be the broker's commissions or fees, or a portion thereof, and to pay it back at a later date, or over a plurality of payments to the entity or entities who wish to bear the risk of collecting the payment(s). The right to the payment(s) may be unsecured, or secured (e.g. the seller's car, jewelry, or new house as collateral).

The novel features which are considered characteristic for the invention are set forth in the appended claims. The invention itself, however, both as to its steps and its method of operation, will be better understood from the following description of the specific embodiments when read and understood in connection with the accompanying drawings.

### Definitions Used in the Specification

The following definitions help define words used in this specification. The ordinary meaning of the following words include, but are not limited to the following definitions.

1. Administrator: A franchisor, financial broker, or any other entity that is not the “financing entity” (defined below). One who serves as a go-between, broker, manager, or facilitator between the real estate broker, the applicant, and the financing entity, that is not the “financing entity” (defined below).

2. Applicant: One who applies (usually the seller, but possibly the buyer, or both) to have the right to not pay the full broker's compensation (commissions or fees) at the closing, and, if approved, has the duty to repay such compensation.

3. Broker: An agent employed to make bargains and contracts for compensation. A dealer in securities issued by others, real estate, goods, or services. A middleman or negotiator between parties. A person dealing with another for the sale of property. A person whose business it is to bring buyer and seller together. One who is engaged for others, on a commission, to negotiate contracts. Persons who procures the purchase or sale of land, acting as intermediary between vendor and purchaser, and who negotiate loans on real-estate security, manage, and lease estates. A person employed in negotiating the sale, purchase, or exchange of lands on a commission contingent on success. A person authorized by another to act for him, one entrusted with another's business. A person whose business it is to sell, or offer for sale, real estate, houses, stores, buildings, goods, or services, for others, or to rent real estate, houses, stores, buildings, goods, or services for others. A person who conducts auctions and receives a premium, commission, fee, or other compensation.

4. Broker's separate entity: An organization, separate from the broker, but one in which the broker has at least some control, that possesses separate existence for tax purposes. Examples would be corporations, partnerships, estates and trusts. A person, estate, trust, or governmental unit separate from the broker, but one in which the broker has at least some control. A “financing department,” subsidiary, affiliate, agent, sub-entity, sister corporation, or parent, of the broker.

5. Buyer: One who buys; a purchaser of goods, real estate, or services.

6. Closing: As regards to real estate, refers to the final steps of the transaction, wherein title to the real estate is transferred in exchange for payment of the purchase price.

7. Commission(s): The compensation or reward paid to a factor, broker, agent, salesman, bailee, executor, trustee, receiver, etc., sometimes calculated as a percentage on the amount of his transactions or the amount received or expended. The real estate fee that is due and payable to a real estate broker. A recompense for an official or professional service or a charge or emolument or compensation for a particular act or service. Compensation received by a person who can profit from sales at auctions.

8. Compensation: “Commission” or “fee” as defined in this specification, in addition to other applicable definitions consistent with the applicant's invention.

9. Entity: The “financing entity,” “broker's separate entity,” or “administrator” as defined in this specification, in addition to other applicable definitions consistent with the applicant's invention.

10. Fee(s): The compensation or reward paid to a factor, broker, agent, salesman, bailee, executor, trustee, receiver, etc., sometimes calculated as a percentage on the amount of his transactions or the amount received or expended. The real estate fee that is due and payable to a real estate broker. A recompense for an official or professional service or a charge or emolument or compensation for a particular act or service. Compensation received by a person who can profit from sales at auctions.

11. Finance program: The embodiments of applicant's invention will, for ease of reading, sometimes be referred to in the specification as the “finance program.”

12. Financing entity: A bank, mortgage company, refinance company, finance company or other person who in the ordinary course of business makes advances against goods, real estate, or services, or documents of title or who by arrangement with either the seller, buyer, agent, or broker, intervenes in ordinary course to make or collect payment due or claimed under the contract for sale, as by purchasing or paying the seller's draft of making advances against it or by merely taking it for collection whether or not documents of title accompany the draft. “Financing entity” includes also a bank or other person who similarly intervenes between persons who are in the position of seller and buyer in respect to goods (Uniform Commercial Code §2-104), real estate, or services. “Financing entity” includes a finance company, investment group, investor, or franchisor. “Financing entity” also includes a financial broker, a go-between, manager, or facilitator between the broker, the seller, and the financing entity. A lender. An underwriter.

13. Seller: Vendor, one who has contracted to sell property (real or personal) or services. A person who sells, or contracts to sell goods, real estate, or services.

### DRAWING FIGURES

FIG. 1 is a schematic of a transaction at a real estate closing under the prior art.

FIG. 2 is a schematic of a transaction at a real estate closing of sale under an embodiment of the invention.

### Brief List of Reference Numerals Utilized in the Drawings

10—applicant

12—broker

14—broker's separate entity

16—financing entity

### DETAILED DESCRIPTION OF THE INVENTION

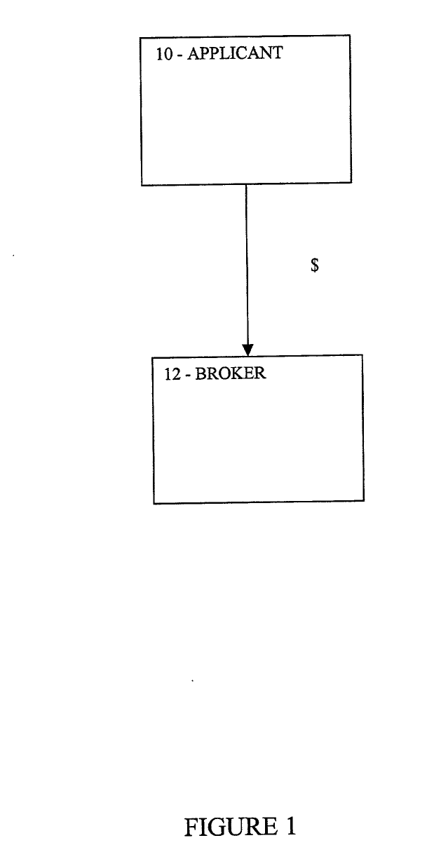

A schematic of the prior art closing is shown in FIG. 1. These are transactions that involve a real estate broker who is due compensation (commission or fee) and provide that such compensation be paid in full at the time of closing. The single arrow in FIG. 1 indicates the direction of the broker's (12) compensation, from the applicant (10), (usually the seller, but could be the buyer, or both) to the broker (12).

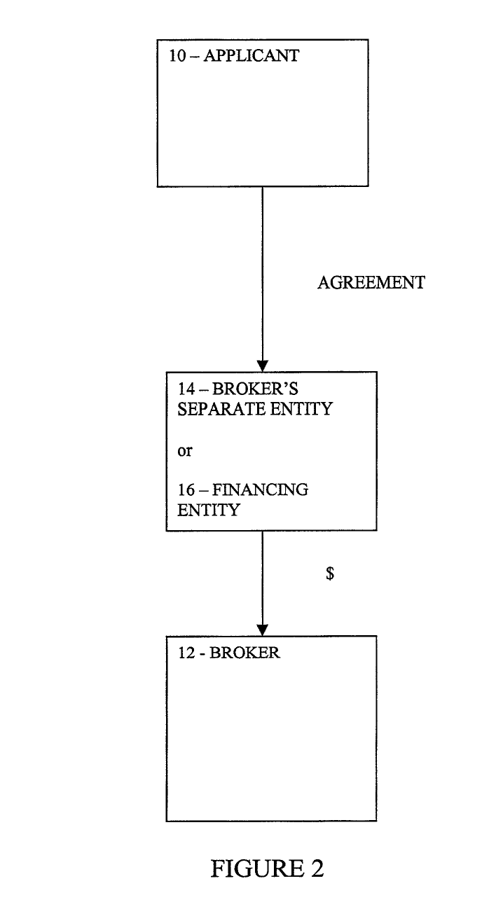

A typical embodiment of the business method-type application as it applies to a real estate closing is shown in FIG. 2. The arrow from the top to the middle box illustrates the agreement that the applicant (10) can have with the entity that wishes to finance the compensation, illustrated in the middle box. Those entities include the broker's separate entity (14), or the financing entity (16). The lower box illustrates the closing, where the broker (12) will receive the compensation from the broker's separate entity (14), or financing entity (16). The real estate broker (12) offers the applicant (10) of such commission or fee the option of deferring payment of the commission or fee, which would be due the broker at closing, into the future and paying the amount owed later, for example, in increments rather than in full. FIG. 2 illustrates how the issue of real estate commissions or fees is addressed at the closing.

In FIG. 2, the arrow from the middle box to the lower box shows the broker's separate entity (14), or financing entity (16), paying the real estate broker (12) at the closing, the real estate broker's (12) compensation, less any withholdings for interest or charges or service fees as previously agreed.

The broker may underwrite or fund this through any of the following examples;

a) Self-funded by broker (12). The broker (12) uses his/her own funds, borrowed funds or otherwise-acquired funds, to finance the program. This is described below as embodiment 1.

b) Funded by a financing entity directly (16). The broker (12) enters into an agreement with a financing entity (16) to finance the program. This is described below as embodiment 2.

c) Funded by a financing entity (16) indirectly. The broker (12) enters into an agreement with an “administrator,” or financing entity (16), which is not itself the same financing entity (16) that provides the financing, but that serves as a go-between, broker, manager or facilitator between the broker (12) and the financing entity (16) that provides the financing. This is described below as embodiment 3.

The terms and conditions of any agreements would be a matter of negotiations between the involved parties. It is expected that such agreements would address all relevant issues, including, but not limited to, defining the function of each of the involved entities, delineating the responsibilities of each entity, allocating the program's maintenance and operational costs between the entities and providing a method and schedule of compensation for each involved entity.

Having established a method for funding the finance program, the broker (12) now offers the finance program as an option to qualified clients from whom a commission or fee would, in the prior art, become due at the closing of a transaction. Those clients who choose to participate will fill out an application and subject themselves to such credit requirements as the broker or financing entity may legally impose.

It is acknowledged that real estate brokers (12) may not be financially capable of funding or underwriting a finance program as defined and described, on their own, and it is possible that such direct financing may be restricted or prohibited by law.

For real estate brokers (12) who cannot or choose to not underwrite a finance program directly, or where they are legally restricted, the finance program may be funded through the real estate broker's agreement with

a) a financing entity (16) directly; or

b) an administrator.

The real estate broker (12) will enter into an agreement with either a financing entity (16) or an administrator, which agreement will govern their relationship with respect to the finance program and will, among other things:

a) define the function of each of the involved entities (financing entity (16), administrator, etc.);

b) delineate the responsibilities of each entity-explain in detail the areas and limits of performance expected from each of the involved entities;

c) allocate between the entities the maintenance and operational costs such as administrative, marketing, and financing expenses;

d) provide a method and schedule of compensation for each entity.

Embodiment 1—Funded by Real Estate Broker

One embodiment of the invention is a method by which all or part of the commission or fee which is normally due and payable to a real estate broker (12) at the time of closing are instead, financed over a period of time.

The manner and process of making and using the invention are described in the following steps.

1. A real estate broker (12) offers a program under which applicant(s) (10), if approved, finance all or part of the real estate commission or fee that would otherwise be due and payable to the real estate broker (12) in full at the time of closing.

2. The real estate broker's (12) applicants (10) who choose to participate in the finance program will fill out an application and subject themselves to credit verification.

3. The real estate broker (12), or the broker's separate entity (14) may offer a variety of plans under the finance program, including certain special terms to preferred clients. For example, clients who finance over a certain dollar amount, or who agree to both buy and sell property through the broker, might become eligible for a reduced interest rate plan. Other finance programs might even go further by offering zero percent interest or even zero payments due for a stated period, or a balloon payment at a later date.

4. After receipt of the client's completed finance program application, credit report and any additional documents or fees that may apply, the real estate broker (12) and/or the broker's separate entity (14) will process the application and approve or reject the application, or require further information.

5. If the finance program application is approved by the broker (12), and/or the broker's separate entity (14), the applicant (10) may be sent a complete finance program package for their review. The escrow-closing agent will also be provided with finance program documents, such as a finance program agreement, containing the full terms and conditions of the finance program, which will bind the parties to perform accordingly, a note or other financing instrument including a payment schedule and the applicant's duty to pay, that must be properly completed and signed by the applicant at closing. Other documents may include any security instrument that the real estate broker (12), financing entity (16), or administrator may insist upon, any legally-mandated disclosure, such as a Truth-in-Lending statement, and instructions regarding the commission disbursement and how the finance program will affect figures and amounts on a settlement statement. The real estate broker (12), financing entity (16), or administrator, or other entity, will cause entities involved in the closing of the transaction to receive timely copies of all documents mentioned above, prior to closing. The parties receiving documents for review may include (a) the applicant or their legal representative, (b) the applicant's real estate broker (12), or (c) the title insurance or escrow closing agent.

6. At the closing of the real estate transaction, the applicant (10) will sign the usual real estate closing documents as well as documents relating to the finance program. No finds will be due from the applicant (10) at the time of closing for real estate commissions or fees. Instead, the real estate brokers (12) themselves would not receive any commission or fee at the closing, unless the broker's separate entity (14) would pay to the real estate broker (12), on behalf of the applicant (10), such amounts as would have been due and paid by the client in real estate commissions or fees. An agreed upon amount may be withheld for service charges and/or interest, depending on the finance program plan in effect.

7. The applicant (10) will now owe to the real estate broker (12) or the broker's separate entity (14) the total amount of the real estate commission or fee plus any fees and interest charges agreed upon, which balance will be payable according to the schedule of payments provided pursuant to the finance program.

Embodiment 2-Funded by a Financing Entity Directly Under Agreement with Real Estate Broker

The second embodiment of the invention is described in the following steps:

1. A real estate broker (12) offers a program under which applicants (10), if approved, finance all or part of the real estate commission or fee that would otherwise be due and payable to the real estate broker (12) in full at the time of closing.

2. The real estate broker's (12) applicants (10) who choose to participate in the finance program will fill out an application and subject themselves to such credit verification as may be required by the broker (12), broker's separate entity (14), or financing entity (16). The real estate broker (12), or broker's separate entity (14) will forward all applications, any fees and related finance program documents to the financing entity (16).

3. The real estate broker (12), broker's separate entity (14) or financing entity (16) may offer a variety of plans under the finance program, including certain special terms to preferred clients. For example, clients who finance over a certain dollar amount, or who agree to both buy and sell property through the broker (12), might become eligible for a reduced interest rate plan under the finance program. Other finance program plans might go even further by offering zero percent interest or even zero payments due for a stated period. Depending on how the issue is addressed in the real estate broker's (12) agreement with the financing entity (16), the real estate broker (12) might have to compensate the financing entity (16) for part or all of such losses.

4. After receipt of the real estate broker's (12) applicant's (10) completed application, credit report and additional documents or fees that may apply, the financing entity (16) will process the application and approve or reject it, or require further information.

5. If the finance program application is approved by the financing entity (16), the applicant (10) may be sent a complete finance program package for their review. The escrow-closing agent will also be provided with finance program documents, such as a finance program agreement, containing the full terms and conditions of the finance program, which will bind the parties to perform accordingly, a note or other financing instrument including a payment schedule and the applicant's duty to pay, that must be properly completed and signed by the applicant (10) at closing. Other documents may include any security instrument that the real estate broker (12), broker's separate entity (14), financing entity (16), or administrator may insist upon, any legally-mandated disclosure, such as a Truth-in-Lending statement, and instructions regarding the commission disbursement and how the finance program will affect figures and amounts on a settlement statement. The real estate broker (12), broker's separate entity (14), financing entity (16), or administrator, or other entity, will cause entities involved in the closing of the transaction to receive timely copes of all documents mentioned above, prior to closing. The parties receiving documents for review may include (a) the applicant (10) or their legal representative, (b) the applicant's (10) real estate broker (12), or (c) the title insurance or escrow closing agent.

6. At the closing of the real estate transaction, the applicant (10) will sign the usual real estate closing documents as well as documents relating to the finance program. No funds will be due from the applicant (10) at the time of closing for real estate commissions or fees. Instead, the financing entity (16) will pay to the real estate broker (12), on behalf of the applicant (10), such amounts as would have been due and paid by the client in real estate commissions or fees. An agreed upon amount may be withheld for service charges and/or interest, depending on the finance program plan in effect.

7. The applicant (10) will now owe to the financing entity (16), the total amount of the real estate commission or fee plus any fees and interest charges agreed upon, which balance will be payable according to the schedule of payments provided pursuant to the finance program.

8. Having collected its commission or fee, the real estate broker (12) need not have further involvement or exposure with respect to the finance program.

Embodiment 3-Funded by Agreement Between Financing Entity, Administrator, and Real Estate Broker

The third embodiment of the invention is described in the following steps:

1. A real estate broker (12) offers a program under which applicants (10), if approved, finance all or part of the real estate commission or fee that would otherwise be due and payable to the real estate broker (12) in fill at the time of closing.

2. The real estate broker's (12) applicants (10) who choose to participate in the finance program will fill out an application and subject themselves to such credit verification as may be required by the broker (12), broker's separate entity (14), financing entity (16), or administrator.

3. The real estate broker (12), broker's separate entity (14), financing entity (16), or administrator may offer a variety of plans under the finance program, including certain special terms to preferred clients. For example, clients who finance over a certain dollar amount, or who agree to both buy and sell property through the broker (12), might become eligible for a reduced interest rate plan under the finance program. Other finance program plans might go even further by offering zero percent interest or even zero payments due for a stated period. Depending on how the issue is addressed in the real estate broker's (12) agreement with the administrator and the financing entity (16), the real estate broker (12) might have to compensate either, or both of them for part or all of such losses.

4. After receipt of the real estate broker's (12) applicant's (10) completed application, credit report and additional documents or fees that may apply, the administrator will process the application and present it for approval by the financing entity (16).

5. If the finance program application is approved by the financing entity (16), the applicant (10) may be sent a complete finance program package for their review. The escrow-closing agent will also be provided with finance program documents, such as a finance program agreement, containing the fill terms and conditions of the finance program, which will bind the parties to perform accordingly, a note or other financing instrument including a payment schedule and the applicant's (10) duty to pay, that must be properly completed and signed by the applicant (10) at closing. Other documents may include any security instrument that the real estate broker (12), broker's separate entity (14) financing entity (16), or administrator may insist upon, any legally-mandated disclosure, such as a Truth-in-Lending statement, and instructions regarding the commission disbursement and how the finance program will affect figures and amounts on a settlement statement. The real estate broker (12), broker's separate entity (14), financing entity (16), or administrator, or other entity, will cause entities involved in the closing of the transaction to receive timely copies of all documents mentioned above, prior to closing. The parties receiving documents for review may include (a) the applicant (12) or their legal representative, (b) the applicant's (10) real estate broker (12), or (c) the title insurance or escrow closing agent.

6. At the closing of the real estate transaction, the applicant (10) will sign the usual real estate closing documents as well as documents relating to the finance program. No finds will be due from the applicant (10) at the time of closing for real estate commissions or fees. Instead, the financing entity (16), either directly or through the administrator, will pay to the real estate broker (12), on behalf of the applicant (10), such amounts as would have been due and paid by the client in real estate commissions or fees. An agreed upon amount may be withheld for service charges and/or interest, depending on the finance program plan in effect.

7. The applicant (10) will now owe to the financing entity (16), either directly or through the administrator, the total amount of the real estate commission or fee plus any fees and interest charges agreed upon, which balance will be payable according to the schedule of payments provided pursuant to the finance program.

8. Having collected its commission or fee, the real estate broker (12) need not have further involvement or exposure with respect to the finance program.

### Conclusions, Ramifications and Scope of the Invention

It will be understood that each of the useful, concrete and tangible results obtained from using the methods in the specification may also find a useful application in other types of methods and applications differing from the type described above.

While the invention has been illustrated and described as embodied in a business method to defer the payment of a portion, or entire sales commission or fee, it is not intended to be limited to the details shown, since it will be understood that various omissions, modifications, substitutions and changes in the methods, useful, concrete, and tangible results, definitions, forms and details of the method illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

I claim:

1. A method to defer payment of compensation comprising the steps of:
a) a seller (1) selling something to a buyer (2) with the assistance of a broker (3), whereby an applicant (4) incurs the duty to pay compensation (5);
b) said broker (3) receiving said compensation (5) from a broker's separate entity (6), at a closing (7); and
c) said broker's separate entity (6), having the right to receive said compensation (5), from said applicant (4), after said closing (7).

2. A method to defer payment of compensation comprising the steps of:
a) a seller (1) selling something to a buyer (2) with the assistance of a broker (3), whereby an applicant (4) incurs the duty to pay compensation (5);
b) said broker (3) receiving said compensation (5) from a financing entity (8), at a closing (7); and
c) said financing entity (8), having the right to receive said compensation (5), from said applicant (4), after said closing (7).

3. A method to defer payment of compensation comprising the steps of:
a) a seller (1) selling something to a buyer (2) with the assistance of a broker (3), whereby an applicant (4) incurs the duty to pay compensation (5);
b) said broker (3) receiving said compensation (5) from a financing entity (8), at a closing (7); and
c) an administrator (9) having the right to receive said compensation (5) from said applicant (4), on behalf of said financing entity (8) after said closing (7).

4. A method to defer payment of compensation comprising the steps of:
a) a seller (1) selling something to a buyer (2) with the assistance of a broker (3), whereby an applicant (4) incurs the duty to pay compensation (5);
b) said broker (3) does not receive said compensation (5), at a closing (7); and
c) said broker (3), having the right to receive said compensation (5), from said applicant (4), after said closing (7).

5. In a transaction for the sale of property involving a seller (1), a buyer (2), and a broker (3), where the broker (3) charges compensation (5) for assisting in the transaction, a method for loaning the broker's (3) compensation (5) including the steps of:
a) a seller (1) selling something to a buyer (2) with the assistance of a broker (3), whereby an applicant (4) incurs the duty to pay compensation (5);
b) said broker (3) receiving said compensation (5) from a broker's separate entity (6), at a closing (7); and
c) said broker's separate entity (6), having the right to receive said compensation (5), from said applicant (4), after said closing (7).

6. In a transaction for the sale of property involving a seller (1), a buyer (2), and a broker (3), where the broker (3) charges compensation (5) for assisting in the transaction, a method for loaning the broker's (3) compensation (5) including the steps of:
a) a seller (1) selling something to a buyer (2) with the assistance of a broker (3), whereby an applicant (4) incurs the duty to pay compensation (5);
b) said broker (3) receiving said compensation (5) from a financing entity (8), at a closing (7); and
c) said financing entity (8), having the right to receive said compensation (5), from said applicant (4), after said closing (7).

7. In a transaction for the sale of property involving a seller (1), a buyer (2), and a broker (3), where the broker (3) charges compensation (5) for assisting in the transaction, a method for loaning the broker's (3) compensation (5) including the steps of:
a) a seller (1) selling something to a buyer (2) with the assistance of a broker (3),
whereby an applicant (4) incurs the duty to pay compensation (5);
b) said broker (3) receiving said compensation (5) from a financing entity (8), at a closing (7); and
c) an administrator (9) having the right to receive said compensation (5) from said applicant (4), on behalf of said financing entity (8) after said closing (7).

8. In a transaction for the sale of property involving a seller (1), a buyer (2), and a broker (3), where the broker (3) charges compensation (5) for assisting in the transaction, a method for loaning the broker's (3) compensation (5) including the steps of:
a) a seller (1) selling something to a buyer (2) with the assistance of a broker (3), whereby an applicant (4) incurs the duty to pay compensation (5);
b) said broker (3) does not receive said compensation (5), at a closing (7); and
c) said broker (3), having the right to receive said compensation (5), from said applicant (4), after said closing (7).

9. A method to defer payment of compensation comprising the steps of:
a) a seller (1) selling something to a buyer (2) with the assistance of a broker (3), whereby a seller (1) incurs the duty to pay compensation (5);
b) said broker (3) receiving said compensation (5) from a broker's separate entity (6), at a closing (7); and
c) said broker's separate entity (6), having the right to receive said compensation (5), from said seller (1), after said closing (7).

10. A method to defer payment of compensation comprising the steps of:
a) a seller (1) selling something to a buyer (2) with the assistance of a broker (3), whereby a seller (1) incurs the duty to pay compensation (5);
b) said broker (3) receiving said compensation (5) from a financing entity (8), at a closing (7); and
c) said financing entity (8), having the right to receive said compensation (5), from said seller (1), after said closing (7).

11. A method to defer payment of compensation comprising the steps of:
a) a seller (1) selling something to a buyer (2) with the assistance of a broker (3), whereby a seller (1) incurs the duty to pay compensation (5);
b) said broker (3) receiving said compensation (5) from a financing entity (8), at a closing (7); and
c) an administrator (9) having the right to receive said compensation (5) from said seller (1), on behalf of said financing entity (8) after said closing (7).

12. A method to defer payment of compensation comprising the steps of:
a) a seller (1) selling something to a buyer (2) with the assistance of a broker (3), whereby a seller (1) incurs the duty to pay compensation (5);
b) said broker (3) does not receive said compensation (5), at a closing (7); and
c) said broker (3), having the right to receive said compensation (5), from said seller (1), after said closing (7).
